(19) United States
(12) Patent Application Publication
(10) Pub. No.: US 2009/0053965 A1
(43) Pub. Date: Feb. 26, 2009

(54) METHOD FOR MANUFACTURING DISPLAY DEVICE AND COMPOSITION OF SEALANT THEREFOR

(75) Inventors: Yeon-eu KIM, Asan-si (KR); Young-geol SONG, Yongin-si (KR); Yu-jun KIM, Incheon (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/197,009

(22) Filed: Aug. 22, 2008

(30) Foreign Application Priority Data
Aug. 24, 2007 (KR) 10-2007-0085697

(51) Int. Cl. G02F 1/1333; B32B 37/06; C08L 63/00

(52) U.S. Cl. 445/25; 156/272.6; 525/523

(57) ABSTRACT

A method for manufacturing a display device is disclosed, which includes forming a main sealant which surrounds a display region on a first substrate and an auxiliary sealant which is disposed along and outside the main sealant and has an epoxy resin and a diazonaphthoquinone type initiator, disposing a second substrate on the first substrate and aligning the first and second substrates, and adhering the first and second substrates by curing the auxiliary sealant with UV radiation.

This application claims priority to Korean Patent Application No. 10-2007-0085697, filed on Aug. 24, 2007, and all the benefits accruing therefrom under 35 U.S.C. 119(a), the content of which is incorporated herein by reference in its entirety.

### BACKGROUND OF THE INVENTION

1. Field of the Invention

The present invention relate to a method for manufacturing a display device and a composition of a sealant therefor.

2. Description of the Related Art

In recent years, cathode ray tubes (“CRTs”) have been replaced by newer generation, flat panel display devices such as liquid crystal displays (“LCDs”), organic light emitting devices (“OLED”), and electrophoretic display devices.

Typically, an LCD can include a first substrate having thin film transistors, a second substrate coplanar with and facing the first substrate, and a liquid crystal layer interposed between the first and second substrates. The first and second substrates are adhered to one another with a sealant.

Patterns including signal lines, pixel electrodes, a black matrix and color filters are formed in the first and second substrates in the LCD. Aligning the first and second substrates precisely is critical to providing improved display quality.

However, the first and second substrates can become misaligned during the manufacturing process. Imprecise alignment thereby reduces the display quality.

### BRIEF SUMMARY OF THE INVENTION

Additional aspects and/or advantages of the present invention will be set forth in part in the description which follows and, in part, will be obvious from the description, or may be learned by practice of the present invention.

The foregoing and/or other aspects of the present invention are also achieved by providing, in an embodiment, a method of making a display device, including: forming a main sealant to surround a display region on a first substrate, and an auxiliary sealant which is disposed in a circumference of the main sealant and has an epoxy resin and a diazonaphthoquinone type initiator; disposing a second substrate on the first substrate and aligning the first and second substrates; and adhering the first and second substrates by curing the auxiliary sealant with UV.

The epoxy resin can include at least two epoxy groups.

The epoxy resin can include a novolac type epoxy resin.

The novolac type epoxy resin can include at least one of a phenol novolac epoxy resin and a cresol novolac epoxy resin.

The epoxy resin can have a chemical structure of chemical formula 1.

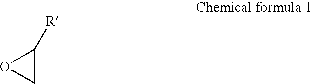

Here, R′ includes at least one selected from the group consisting of amide, ester, ether, sulfide, sulfoxide, hydroxide, halide, imide, an aza group, amine, an azo group, aldehyde, a carboxy group, anhydride, urea, an alkyl group, and an alkylaryl.

The molar ratio between the diazonaphthoquinone type initiator and the epoxy resin can be 1:10 to 1:100, respectively.

The diazonaphthoquinone type initiator can include a diazonaphthoquinone-novolac resin.

The novolac resin of the diazonaphthoquinone type initiator can include a phenol novolac resin, and the number-average molecular weight (Mn) of the phenol novolac resin is from 1,000 to 50,000 g/mol.

The auxiliary sealant can further include a hardener.

The molar ratio between the hardener and the epoxy resin can be 1:5 to 1:20, respectively.

The hardener can include a dihydrazide material.

The dihydrazide material can include at least one selected from the group consisting of valine dihydrazide, adipic acid dihydrazide and sebacic acid dihydrazide.

The method of making can further include curing the main sealant by using heat after the auxiliary sealant is cured, wherein the glass transition temperature of the cured auxiliary sealant is higher than the curing temperature of the main sealant.

The main sealant can be cured by heating at about 100° C. to about 140° C.

The method of making can further include: forming a mother substrate assembly by cutting the first and second substrates having the main sealant along a cutting line outside of the main sealant; and injecting liquid crystals between the first and second substrates through an injection opening formed in the main sealant, wherein the auxiliary sealant is disposed outside of the cutting line.

The liquid crystals can include liquid crystals having a twisted nematic (“TN”) mode.

The foregoing and/or other aspects of the present invention can be achieved by provision of a composition of a sealant which includes diazonaphthoquinone-novolac resin and a novolac type epoxy resin present in a molar ratio of 1:10 to 1:100, respectively.

The novolac resin of the diazonaphthoquinone-novolac resin can include a phenol novolac resin, wherein the number-average molecular weight (Mn) of the phenol novolac resin is from 1,000 to 50,000 g/mol.

The composition of the sealant can further include a hardener which is a dihydrazide type material.

### BRIEF DESCRIPTION OF THE DRAWINGS

The above and/or other aspects of the present invention will become apparent and more readily appreciated from the following detailed description of the invention, taken in conjunction with the accompanying drawings of which:

FIG. 1 is an exploded perspective view of a liquid crystal display according to an exemplary embodiment of the present invention;

FIG. 2 is a sectional view of the liquid crystal display, taken along the line II-II in FIG. 1;

FIGS. 3A to 3G illustrate a method for manufacturing the liquid crystal display shown in FIG. 1;

FIG. 4 is an exploded perspective view of a liquid crystal display according to another exemplary embodiment of the present invention; and

FIGS. 5A and 5B illustrate a method for manufacturing the liquid crystal display shown in FIG. 4.

### DETAILED DESCRIPTION OF THE INVENTION

Hereinafter, exemplary embodiments of the present invention will be described with reference to accompanying drawings, wherein like numerals refer to like elements and repetitive descriptions will be avoided as necessary.

It will be understood in the following disclosure of the present invention, that as used herein, the singular forms “a”, “an” and “the” are intended to include the plural forms as well, unless the context clearly indicates otherwise. It will be further understood that the terms “comprise”, “comprises”, and “comprising,” when used in this specification, specify the presence of stated features, integers, steps, operations, elements, components, and combination of the foregoing, but do not preclude the presence and/or addition of one or more other features, integers, steps, operations, elements, components, groups, and combination of the foregoing.

It will be understood that when an element is referred to as being “on” another element, or when an element is referred to as being “disposed between” two or more other elements, it can be in at least partial contact with the other element(s), or an intervening element or elements may be present therebetween. In contrast, when an element is referred to as being “directly on” another element, the elements are understood to be in at least partial contact with each other, unless otherwise specified. Spatially relative terms, such as “between”, “in between” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. The device may be otherwise oriented (rotated 90 degrees, inverted, or at other orientations) and the spatially relative descriptors used herein interpreted accordingly. Likewise, use of the term “opposite”, unless otherwise specified, means on the opposing side or surface of the element. For example, where a surface of a layer is said to be opposite another surface or element, it is located on the opposing surface of the layer coplanar with the first surface unless otherwise specified.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, a liquid crystal display will be exemplified as a display device, but should not be considered by this exemplification as limited thereto. For example, practice of the present invention as disclosed herein can be applied to other display devices such as an organic light emitting device or an electrophoretic display device.

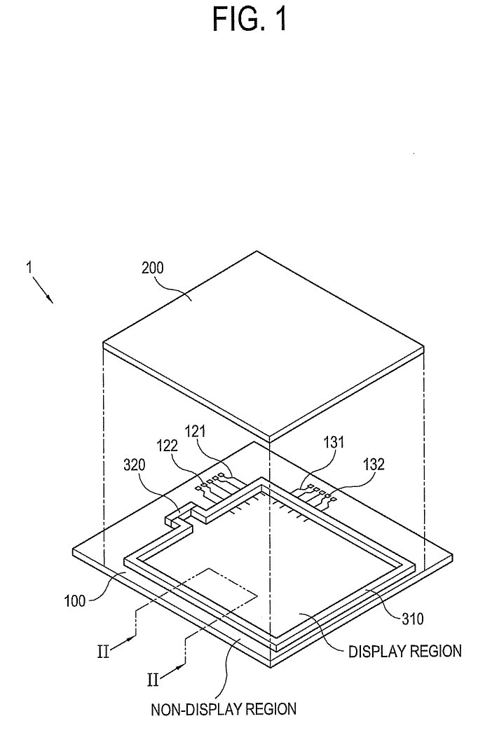

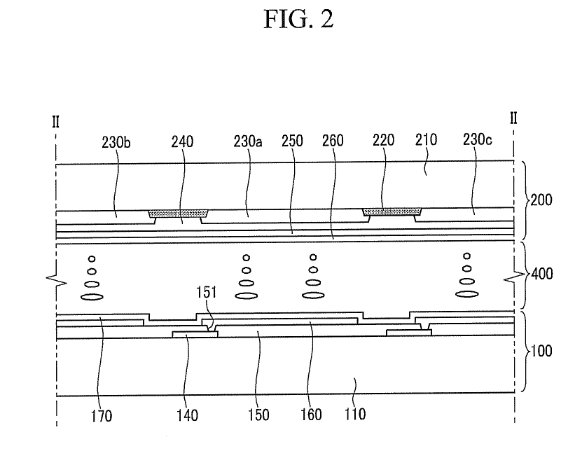

Referring to FIGS. 1 and 2, a liquid crystal display which is made according to a method of the present invention will be described.

FIG. 1 is an exploded perspective view of a liquid crystal display according to an exemplary embodiment of the present invention and FIG. 2 is a sectional view of the liquid crystal display, taken along the line II-II in FIG. 1.

As shown in FIG. 1, a liquid crystal display 1 includes a first substrate 100, a second substrate 200, and sealants 310 and 320 disposed on a surface of the first substrate 100. For convenience, FIG. 1 does not illustrate a liquid crystal layer 400 shown in FIG. 2. The sealants 310 and 320 include a main sealant 310 which substantially surrounds a display region (DISPLAY REGION in FIG. 1) on the surface of first substrate 100, and a capping sealant 320 which spans the interim distance between ends of the sealant 310 which does not completely surround the display region, such that the combination of sealants 310 and 320 completely surround the display region.

The first substrate 100 is larger than the second substrate 200. The inside part of the first substrate 100 bounded by sealants 310 and 320 includes the display region while the outside part thereof is a non-display region (NON-DISPLAY REGION in FIG. 1). The first substrate 100 includes an array of gate lines 121 which extend to the display region, gate pads 122 which connect with the gate line 121 and are disposed in the non-display region, an array of data lines 131 which extend to the display region and data pads 132 which connect with the data lines 131 and are disposed in the non-display region.

One gate line 121 and one data line 131 (not shown in FIG. 2) are connected to one thin film transistor 140 (FIG. 2). The gate line 121 applies a gate signal synthesized with a gate-on voltage and a gate-off voltage to the thin film transistor 140 while the data line 131 applies a data voltage to the thin film transistor 140.

Each of the gate pads 122 receives a gate signal from a gate driver (not shown), and each of the data pads 122 receives a data voltage from a data driver (not shown).

In one exemplary embodiment, the gate pads 122 can be omitted.

Sealants 310 and 320 adhere the first and second substrates 100 and 200 to each other, and together with the first and second substrates 100 and 200, surround and enclose the liquid crystal layer 400. The sealants 310 and 320 are formed in the non-display region along and outside the circumference of the display region. The sealants 310 and 320 include an epoxy resin, and can further include an acrylic resin, an amine type hardener, and a filler such as alumina powder, or the like.

Referring to FIG. 2, the liquid crystal display 1 will be described in more detail.

The first substrate 100 includes a plurality of thin film transistors 140 formed on a surface of a first insulating substrate 110. As described above, thin film transistors 140 are connected to the gate lines 121 and the data lines 131. The first insulating substrate 110 can be made of an electrically insulating material such as, for example, glass, quartz, or plastic.

An insulating layer 150 is formed on the insulating substrate 110 and over a surface of the thin film transistors 140. A plurality of contact holes 151 are formed in the insulating substrate 150 to expose portions of the thin film transistors 140 therethrough.

A plurality of pixel electrodes 160 are formed on a surface of the insulating layer 150 opposite the insulating substrate 110. The pixel electrodes 160 includes a transparent conductive material such as indium tin oxide (“ITO”) and indium zinc oxide (“IZO”). The pixel electrodes 160 are connected to the thin film transistors 140 through the contact holes 151.

A first alignment layer 170 is formed on a surface of the pixel electrodes 160 opposite the insulating layer 150. The first alignment layer 170 may be made of a suitable material such as, for example, polyimide or silicon oxide.

The second substrate 200 includes a black matrix 220 formed on a surface of a second insulating layer 210. The second insulating substrate 210 may be made of an electrically insulating materials such as, for example, glass, quartz or plastic.

The black matrix 220 serves to prevent external light from entering channel regions (not shown) of the thin film transistors 140.

The black matrix 220 may be formed in a grid pattern. In addition, the black matrix 220 may be made of a suitable black matrix material. The black matrix material can include, for example, chromium oxide or an organic material having a black pigment.

A plurality of color filters 230a-230c are formed on a surface of the second insulating substrate 210. The color filters 230a-230c are disposed portions corresponding to the pixel electrodes 160. The color filters 230a-230c are formed in a regular pattern, and includes three distinct sub layers 230a, 23b and 230c which form a repeating pattern and each of which has a different color, for example, red, green, or blue.

An overcoat layer 240 is formed on a surface of the color filters 230a-230c and the black matrix 220 opposite the second insulating layer 210. The overcoat layer 240 provides a planar surface and protects the color filters 230a-230c.

A common electrode 250 is formed on a surface of the overcoat layer 240 opposite the color filters 230 and the black matrix 220. The common electrode 250 includes a transparent conductive material such as ITO or IZO, and applies a voltage across the liquid crystal layer 400 together with the pixel electrodes 160 to adjust the alignment of the liquid crystal layer 400.

A second alignment layer 260 is formed on a surface of the common electrode 250 opposite the overcoat layer 240. The second alignment layer 260 may be made of a suitable material such as, for example, polyimide or silicon oxide. The first and second alignment layers 170 and 260 are aligned perpendicularly to each other (i.e., are aligned when viewed along the thickness direction of the coplanar first and second alignment layers 170 and 260).

The liquid crystal layer 400 is disposed in a space formed and bounded by the first and second substrates 100 and 200, and within the sealants 310 and 320. The liquid crystal layer 400 desirably has a twisted nematic (TN) mode, which rotates 90° between the first and second alignment layers 170 and 260. The alignment of the liquid crystal layer 400 is changed by a voltage difference between the pixel electrodes 160 and the common electrode 250.

The liquid crystal display 1 can further include a plurality of spacers (not shown) to maintain a gap between the first and second substrates 100 and 200. The spacers can have different shapes such as, for example, a ball spacer or a column spacer.

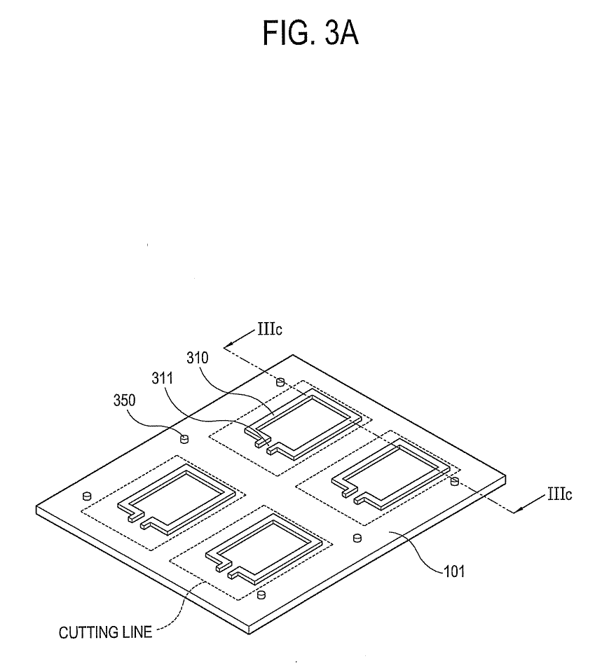

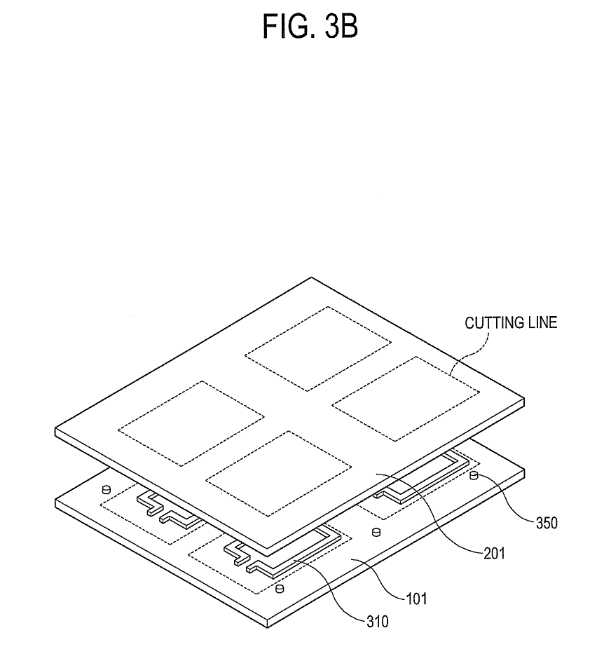

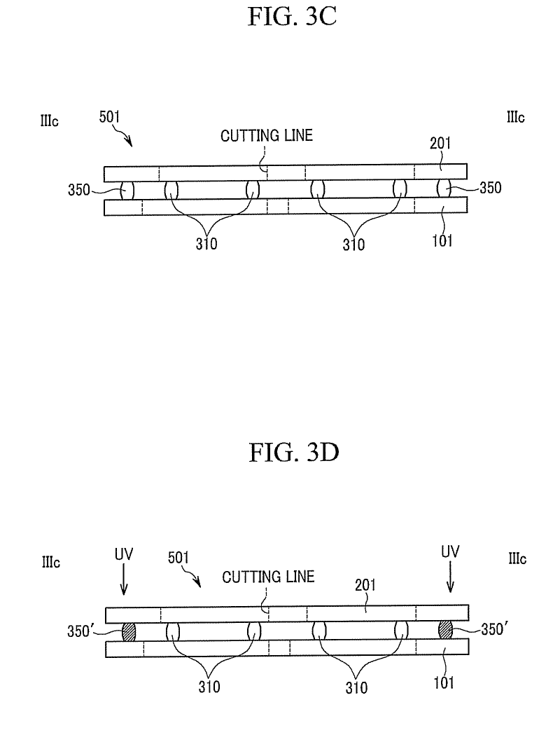

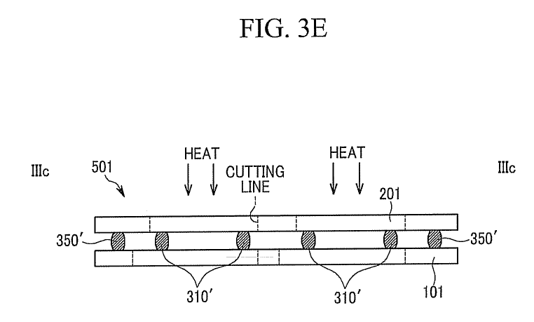

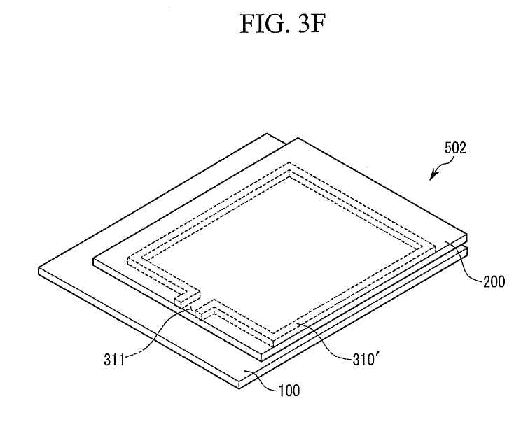

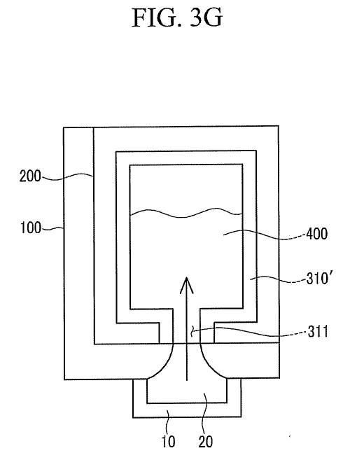

It is critical to align the pixel electrodes 160 of the first substrate 100 and the color filters 230 of the second substrate 200 precisely. When the alignment of the pixel electrodes 160 and the color filters 230 is imprecise, it is difficult to realize a desired image in the display. Also, it is critical to align the thin film transistors 140 of the first substrate 100 and the black matrix 220 of the second substrate 200 precisely. When the alignment of the thin film transistors 140 and the black matrix 220 is imprecise, light from an external can be emitted to the thin film transistors 140, thereby deteriorating the light emitting quality of the thin film transistors 140. The method for manufacturing the liquid crystal display according to an exemplary embodiment of the present invention will now be described with reference to FIGS. 3A and 3G as well as FIGS. 1 and 2.

FIGS. 3A to 3G illustrate a method for manufacturing the liquid crystal display shown in FIG. 1. As shown in FIG. 3A, sealants 310 and 350 are formed on a first mother substrate 101. Where the first mother substrate 101 is cut along a cutting line (CUTTING LINE in FIG. 3A), it becomes the first substrate 100 as shown in FIG. 1. Thus, in FIG. 3, the single first mother substrate 101 can provide four first substrates 100.

The first mother substrate 101 is manufactured according to a method known in the art. Thus, the description of the manufacture of the first mother substrate 101 will be omitted.

The sealants 310 and 350 include main sealants 310 and auxiliary sealants 350. The sealants 310 and 350 are initially uncured.

Each of the main sealants 310 substantially surrounds the display region, but not entirely. An injection opening 311 is thus formed in the main sealant 310 to open a part of the display region. The auxiliary sealants 350 are formed outside of the cutting line (i.e., outside of the non-display region as shown in FIG. 1) and is thus scattered across the first mother substrate 101. The shape of the auxiliary sealants 350 is not limited to that shown in the exemplary embodiment of the present embodiment. For example, the auxiliary sealants 350 can vary in shape and can include an elongated shape.

The auxiliary sealants 350 can be formed by dispensing a composition of a sealant on the first mother substrate 101. The composition of the sealant used to form the auxiliary sealants 350 will be described in detail.

The composition of the sealant includes an epoxy resin and a diazonaphthoquinone type initiator. A molar ratio between the diazonaphthoquinone type initiator to the epoxy resin can be about 1:10 to about 1:100, respectively. The epoxy resin included in the composition of the sealant can represent an unpolymerized epoxy monomer. The composition of the sealant can desirably be afforded in a gel state to readily form the auxiliary sealants 350.

In an embodiment, the epoxy resin can be represented by a following chemical formula 1.

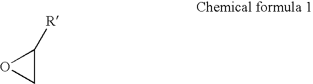

Here, R′ may include at least one selected from the group consisting of amide, ester, ether, sulfide, sulfoxide, hydroxide, halide, imide, an aza group, amine, an azo group, aldehyde, a carboxy group, anhydride, urea, an alkyl group such as a methyl group, and an alkylaryl.

More specifically, the epoxy resin can be represented by following chemical formulas 2 and 3 (where m is 0 or an integer in chemical formula 3).

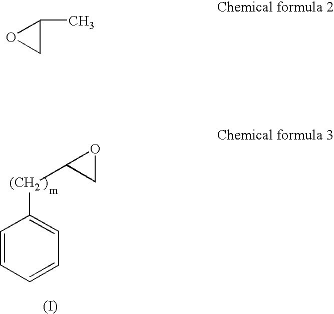

Preferably, the epoxy resin includes at least two epoxy groups, which can be represented by following chemical formulas 4 and 5.

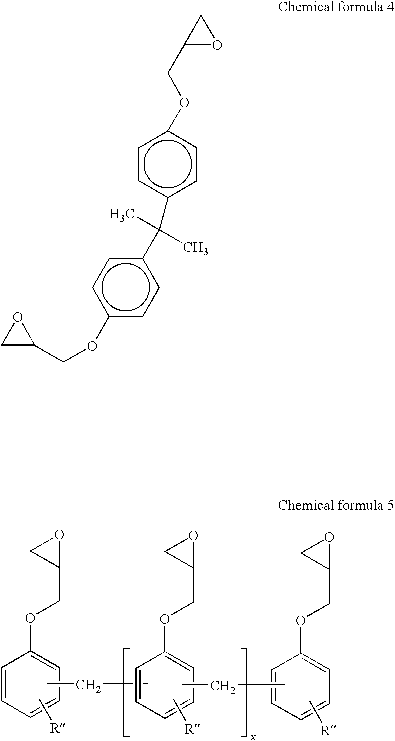

The epoxy resin represented by the chemical formula 5 includes a novolac type epoxy resin, i.e., a phenol-based novolac epoxy resin (where R″═H and x is an integer). In addition to, or alternatively, the epoxy resin can include another novolac type epoxy resin, i.e., a cresol novolac epoxy resin (where R″═CH₃ and x is an integer). It will be understood that, though homopolymers are exemplified with respect to chemical formula 5, novolac type epoxy resins that are contemplated for use as disclosed herein can also include copolymers of glycidyl-substituted phenols and/or cresols with phenol and/or cresols, can have free phenolic —OH groups and/or methylol end groups, and can have branched structures, and therefore representative novolac type epoxy resins should not be considered as limited thereto.

The diazonaphthoquinone type initiator includes a photo initiator such as diazonaphthoquinone or diazonaphthoquinone-novolac resin.

The diazonaphthoquinone-novolac resin can be represented by chemical formula 6.

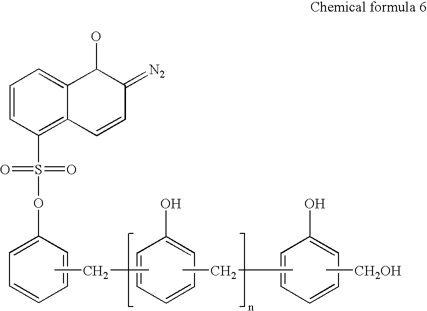

The diazonaphthoquinone-novolac resin represented by chemical formula 6 includes a phenol novolac resin substituted with diazonaphthoquinone groups. The number-average molecular weight (Mn) of the phenol novolac resin used in the diazonaphthoquinone-novolac resin can be from about 1,000 to about 50,000 g/mol. Hereinafter, the diazonaphthoquinone-novolac resin represented by chemical formula 6 will be exemplified for purposes of discussion by the diazonaphthoquinone type initiator substituent groups. The composition of the sealant can further include a hardener. The molar ratio between the hardener and the epoxy resin can be about 1:5 to about 1:20, respectively. The hardener can include a dihydrazide type material. More specifically, the hardener can include at least one selected from the group consisting of valine dihydrazide, adipic acid dihydrazide and sebacic acid dihydrazide.

As shown in FIG. 3B, a second mother substrate 201 is disposed over and aligned with the first mother substrate to thereby provide a mother substrate assembling body shown in FIG. 3C. When the second mother substrate is cut along a cutting line (CUTTING LINE in FIG. 3B), it becomes the second substrate 200 shown FIG. 1. The second mother substrate 201 in FIG. 3B can provide four second substrates 200.

The first and second mother substrates 101 and 201 are aligned so that the pixel electrodes 160 aligns to the corresponding color filters 230 when viewed perpendicular to the plane of first and second mother substrates 101 and 201. Further, the thin film transistors 140 of the first mother substrate 101 and the black matrix 220 of the second mother substrate 201 are aligned to correspond with each other.

The second mother substrate 201 can be manufactured by a method known in the art. Thus, descriptions will be omitted.

FIG. 3C is a sectional view the mother substrate assembling body 501 taken along the line IIIc-IIIc in FIG. 3A, and illustrates the alignment of both the first and second mother substrates 101 and 201 to corresponding with each other, to thereby the mother substrate assembling body 501.

As shown in FIG. 3D, the auxiliary sealants 350 is exposed to ultraviolet (UV) radiation (UV in FIG. 3D) to cure the auxiliary sealants as reference numeral “350′”.

Upon exposure to UV radiation, the diazonaphthoquinone groups of the diazonaphthoquinone-novolac resin rearrange as shown in a reaction formula 1, to form an indene carboxylic acid (“ICA”)-novolac resin. R in the reaction formula 1 refers to the phenolic novolac resin of the diazonaphthoquinone-novolac resin represented by chemical formula 6.

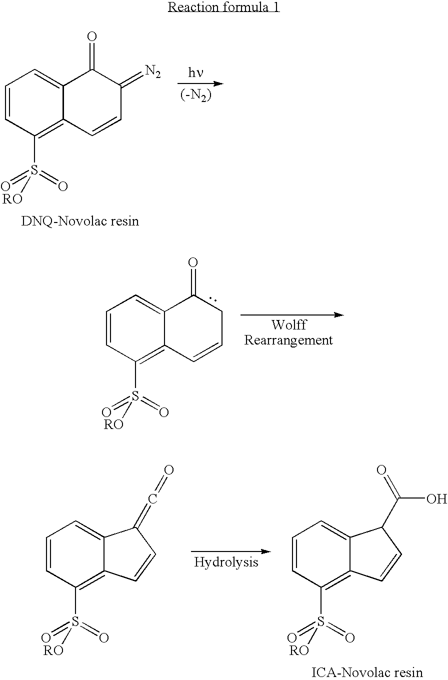

As shown in reaction formula 2, the epoxy resin reacts with the indene carboxylic acid-novolac resin to be cured by polymerization and branching. ICA in the reaction formula 2 refers to ICA-novolac resin. In this way, the auxiliary sealants 350 are cured. The cured auxiliary sealants 350′ have a high glass transition temperature. Where an epoxy resin having at least two epoxy groups is used, a high degree of polymerization and branching can be achieved. Thus, the cured auxiliary sealant 350′ has a higher glass transition temperature when compared with sealants prepared with acrylic resins or epoxy resins having fewer than two epoxy groups per reactive molecule.

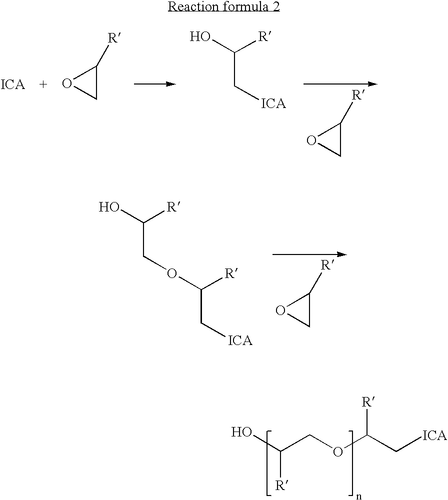

Where a hardener is used, epoxy groups that are not reacted during the curing process of the epoxy resin react with the hardener to form a crosslink. As the crosslink is formed, the glass transition temperature further increases and mechanical strength is further enhanced.

The mother substrate assembling body 501 is then pressed and heated in an oven.

The auxiliary sealants 350 according to the embodiment have a high mechanical strength when cured. The epoxy resin which is the main component of the auxiliary sealants 350 has a higher adhesion to a glass substrate, an insulating layer and an alignment layer, when compared to the adhesion of an acrylic resin toward these substrates and layers. Thus, the auxiliary sealants 350 effectively maintain alignment of the mother substrate assembling body 501 while the mother substrate assembling body 501 is pressed and moved.

Then, the mother substrate assembling body 501 is heated in the oven (HEAT as shown in FIG. 3E) to thereby cure the main sealants 310 to form cured main sealant 310′. The curing temperature of the main sealants 310 can be from about 100° C. to about 140° C. In this embodiment, the glass transition temperature of the auxiliary sealants 350 is higher than the curing temperature of the main sealants 310. Thus, the auxiliary sealants 350 are not deformed until the main sealants 310 are completely cured, and effectively maintain the alignment of the mother substrate assembling body 501.

FIG. 3F shows the result of two mother substrates 101 and 201 after being cut along a cutting line (CUTTING LINE in FIGS. 3A and 3B) to make four substrate assemblies 502. Each substrate assembly 502 includes the first substrate 100, the second substrate 200, and the cured main sealant 310′ disposed between the first and second substrates 100 and 200. That is, the substrate assembly 502 does not include the auxiliary sealants 350. The two substrates 100 and 200 remain a state aligned by the cured main sealant 310′.

As shown in FIG. 3G, liquid crystals 20 are injected between the two substrates 100 and 200 through the injection opening 311 formed in the cured main sealant 310′ to thereby form the liquid crystal layer 400. The liquid crystal is injected according to the following filling method.

The pressure within the space between the both substrates 100 and 200 is reduced in a vacuum chamber (not shown), and the injection opening 311 is contacted to the liquid crystals 20 contained in a liquid crystal accommodator 10. Then, the liquid crystals 20 are injected into the space between the two substrates 100 and 200 through the injection opening 311 by capillary action and pressure difference to thereby form the liquid crystal layer 400. After the liquid crystals 20 are injected, an inert gas is supplied to the chamber to raise the ambient pressure within the chamber. Then, the injection opening 311 is separated from the liquid crystal accommodator 10.

The injection opening 311 is then capped by the capping sealant 320 and the capping sealant 320 is cured, thereby completing the liquid crystal display 1 as shown in FIGS. 1 and 2.

According to the exemplary embodiment, the auxiliary sealants 350 have, when cured, high strength, high glass transition temperature, and good adhesion property to the mother substrates 101 and 201. Thus, the auxiliary sealants 350 effectively maintain precise alignment of the two mother substrates 101 and 201 while the mother substrate assembling body 501 is pressed and moved, and while the main sealant 310 is cured.

The effect of the auxiliary sealants 350 disclosed herein is further demonstrated according to the exemplary embodiment. The example used a phenol novolac epoxy resin as an epoxy resin, a diazonaphthoquinone-novolac resin as a photo initiator and valine dihydrazide as a hardener to form the auxiliary sealants 350. The molar ratio between the photo initiator, the hardener and the epoxy resin was about 1:2:20.

The glass transition temperature of the auxiliary sealants 350, as determined by a thermal mechanical analyzer (“TMA”) was about 148.9° C., and the main sealants 310 were cured at approximately about 140° C.

The alignment error (as measured by the deviation of color filter (of the second substrate) relative to the pixel electrode (of the first substrate), aligned along the x-axis of the plane) for an auxiliary sealants 350 including an acrylic resin as a primary compositional material, ranged from about −3 μm to about 3 μm. However, for an epoxy novolac type sealants used as the auxiliary sealants as disclosed herein, the alignment error ranged from about −1 μm to about 2 μm, thus exhibiting an unexpectedly significant and dramatic improvement in the alignment error.

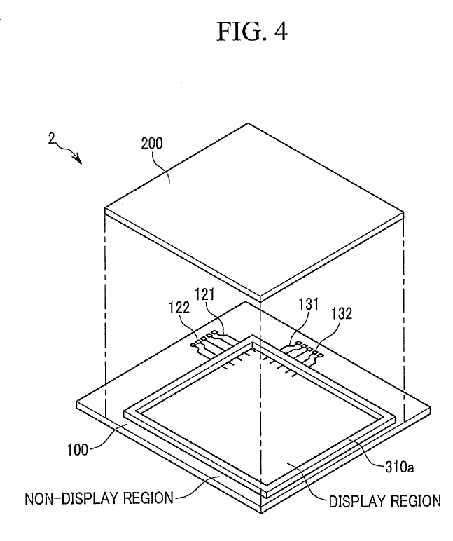

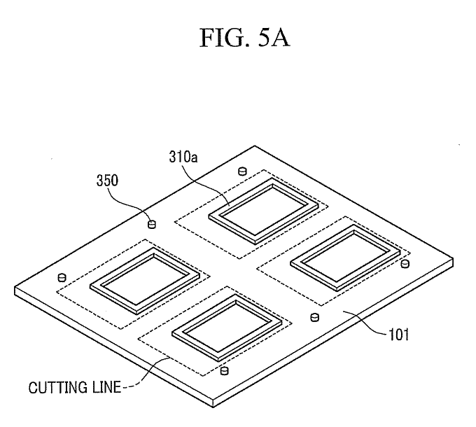

Next, a liquid crystal display according to another exemplary embodiment of the present invention with reference to FIG. 4.

FIG. 4 is an exploded perspective view of a liquid crystal display according to another exemplary embodiment of the present invention.

A structure of a liquid crystal display 2 according to the embodiment is similar to that of the liquid crystal display 1 as shown in FIG. 1. As compared with FIG. 1, the elements performing the same operations are indicates as the same reference numerals, and the detailed description thereof is omitted.

That is, the liquid crystal display 2 according to the embodiment includes a first substrate 100, on which a plurality of gate lines 121 and a plurality of gate pads 122 connected with the gate lines 121, and a plurality of data lines 131 and a plurality of data pads 132 connected with the data lines 131, a sealant 310a disposed between the first and second substrate 100 and 200. In addition, the first substrate 100 includes a plurality of auxiliary sealants 350 scattered thereon like in FIG. 1.

However, unlike FIG. 1, a capping sealant is not provided in the liquid crystal display device 2. The main sealant 310a thus entirely surrounds the display region (DISPLAY REGION in FIG. 4) without an opening.

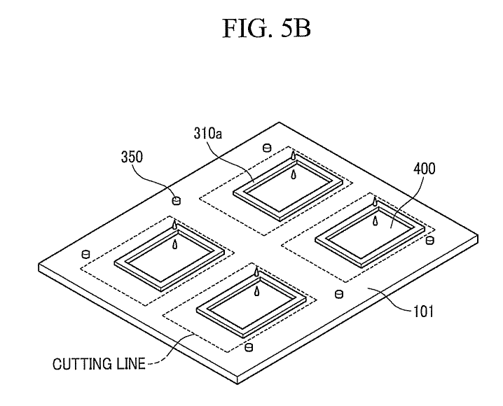

Referring FIGS. 5A and 5B, a method for manufacturing the liquid crystal display in FIG. 4 will be described.

FIGS. 5A and 5B illustrate a method for manufacturing the liquid crystal display shown in FIG. 4.

As shown in FIG. 5A, main sealants 310a are formed on a first mother substrate 101 surrounding display regions without an opening, respectively.

Referring FIG. 5B, liquid crystals 20 are deposited by dropping in a space 400 surrounded by each main sealant 310 to form a liquid crystal layer (not shown). The liquid crystal layer may be not limited to a TN mode liquid crystal layer. Alternatively, the liquid crystal layer can vary and can include liquid crystals having a vertical alignment (VA) mode.

Next, though not shown, a second mother substrate is disposed on the main sealants 310 on the first mother substrate 101 and is aligned, the auxiliary sealants 350 is UV cured, and the main sealants 310 are heat cured and then cut along the cutting line to provide a liquid crystal display 2.

Thus, according to this embodiment, the auxiliary sealants 350 exhibit high strength, high glass transition temperature and good adhesion property to the two mother substrates for the first and second substrates, respectively, when cured, thereby effectively maintaining the alignment of the two mother substrates.

As described above, a method for manufacturing a display device having two substrates that are precisely aligned is provided.

Also, a composition of a sealant used for making a display device having two substrates aligned more precisely is also disclosed.

Although exemplary embodiments of the present invention have been shown and described, it will be appreciated by those skilled in the art that changes can be made without departing from the principles and spirit of the invention, the scope of which is defined in the appended claims and their equivalents.

What is claimed is:

1. A method for manufacturing a display device, comprising:
forming a main sealant which surrounds a display region on a first substrate and an auxiliary sealant which is disposed along and outside the main sealant, where the auxiliary sealant comprises an epoxy resin and a diazonaphthoquinone initiator;
disposing a second substrate on the first substrate and aligning the first and second substrates; and
adhering the first and second substrates by curing the auxiliary sealant with UV radiation.

2. The method of claim 1, wherein the epoxy resin comprises at least two epoxy groups.

3. The method of claim 2, wherein the epoxy resin comprises a novolac epoxy resin.

4. The method of claim 3, wherein the novolac epoxy resin comprises at least one resin selected from the group consisting of a phenol novolac epoxy resin and a cresol novolac epoxy resin.

5. The method of claim 1, wherein the epoxy resin has a chemical structure of chemical formula 1: 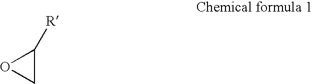
wherein R′ comprises at least one selected from the group consisting of amide, ester, ether, sulfide, sulfoxide, hydroxide, halide, imide, an aza group, amine, an azo group, aldehyde, a carboxy group, anhydride, urea, an alkyl group, and an alkylaryl.

6. The method of claim 1, wherein a molar ratio diazonaphthoquinone initiator to epoxy resin is about 1:10 to about 1:100.

7. The method of claim 1, wherein the diazonaphthoquinone initiator comprises a diazonaphthoquinone-novolac resin.

8. The method of claim 7, wherein the novolac resin of the diazonaphthoquinone initiator comprises a phenol novolac resin, and a number-average molecular weight Mn of the phenol novolac resin is from about 1,000 to about 50,000 g/mol.

9. The method of claim 1, wherein the auxiliary sealant further comprises a hardener.

10. The method of claim 9, wherein a molar ratio of hardener to epoxy resin is about 1:5 to about 1:20.

11. The method of claim 9, wherein the hardener comprises a dihydrazide material.

12. The method of claim 11, wherein the dihydrazide material comprises at least one selected from the group consisting of valine dihydrazide, adipic acid dihydrazide and sebacic acid dihydrazide.

13. The method of claim 1, further comprising curing the main sealant by heating after the auxiliary sealant is cured,
wherein a glass transition temperature of the cured auxiliary sealant is higher than a curing temperature of the main sealant.

14. The method of claim 13, wherein the main sealant is cured by heating at about 100° C. to about 140° C.

15. The method of claim 13, further comprising:
forming a substrate assembly having the main sealant disposed between the first and second substrates by cutting along a cutting line outside of the main sealant; and
injecting liquid crystals between the first and second substrates through an injection opening formed in the main sealant,
wherein the auxiliary sealant is disposed outside of the cutting line.

16. The method of claim 15, wherein the liquid crystals comprise a liquid crystal having a twisted nematic (TN) mode.

17. A composition of a sealant comprising diazonaphthoquinone-novolac resin and a novolac epoxy resin present in a molar ratio of about 1:10 to about 1:100.

18. The composition of claim 17, wherein the novolac resin of the diazonaphthoquinone-novolac resin comprises a phenol novolac resin having a number-average molecular weight Mn of from about 1,000 to about 50,000 g/mol.

19. The composition of claim 17, further comprising a hardener comprising a dihydrazide material.
